(19) United States
(12) Patent Application Publication
(10) Pub. No.: US 2025/0251966 A1
(43) Pub. Date: Aug. 7, 2025

(54) OS CONTEXT SWITCHING

(71) Applicant: Microchip Technology Incorporated, Chandler, AZ (US)

(72) Inventors: Robert Ellis, Gilbert, AZ (US); Michael Catherwood, Tyler, TX (US); Stephen Bowling, Chandler, AZ (US); David Mickey, Chandler, AZ (US)

(73) Assignee: Microchip Technology Incorporated, Chandler, AZ (US)

(21) Appl. No.: 18/978,308

(22) Filed: Dec. 12, 2024

Related U.S. Application Data
(60) Provisional application No. 63/550,532, filed on Feb. 6, 2024.

(51) Int. Cl. G06F 9/48

(52) U.S. Cl. CPC G06F 9/485

(57) ABSTRACT

A device may have a processor to execute a first process comprising a plurality of instructions; a plurality of processor registers to store data associated with one or more of the plurality of instructions; and a context switch instruction, executable by the processor, to move a contiguous set of the plurality of processor registers to or from a memory corresponding to a given memory address, wherein the contiguous set of the plurality of processor registers comprises at least two processor registers and is a proper subset of a total number of processor registers available in the device.

### PRIORITY

This application claims priority to commonly owned U.S. Patent Application No. 63/550,532 filed Feb. 6, 2024, the entire contents of which are hereby incorporated by reference for all purposes.

### FIELD OF THE INVENTION

The present disclosure relates to electronic devices, and more particularly to systems and methods for context switching between processes executing in an operating system (OS) of an electronic device.

### BACKGROUND

Traditionally, in computing products, OS context switches between processes may occur based on a timer event or a release of control by the current process via a yield ( ) function. In either case the context switch may involve saving all the CPU (and coprocessor) registers of a first process in memory pointed to by a stack frame pointer followed by restoring (loading) all the CPU (and coprocessor) registers of a second process from memory.

General OS operations typically do not know in advance how many registers the outgoing process is using, so all available CPU (and coprocessor) registers may be saved. Embedded applications running a real time OS (RTOS) are built with statically processed threads, meaning there are no dynamically loaded processes that are not known at compile time.

The overhead of saving and restoring all available CPU (and coprocessor) registers can take a substantial amount of time, and for small, targeted processes can take longer than the process executes. This context switching can present itself as application response latency and overall reduction in system level performance. In other words, the general-purpose OS context switching times can limit overall application bandwidth and response times.

These limitations may be increased by CPU designs that increase the number of working registers and co-processor registers sets (i.e., floating-point processors). Indeed, as the complexity of CPUs and DSPs increase, the time to perform context switching increases, thus reducing application performance.

Accordingly, there is a need for systems and methods to support more efficient context switching between processes executing in an OS of an electronic device.

### SUMMARY

According to an example, a method may include analyzing a first process, the first process to be executed by an operating system of an electronic device. The method may include determining a first number of processor registers used by the first process, wherein the first number of processor registers is at least two processor registers and is a proper subset of a total number of processor registers available in the electronic device. In an example, the proper subset of the total number of processor registers available in the electronic device may include processor registers that are contiguously addressed. In the same or different examples, the total number of processor registers available in the electronic device may include integer registers and floating point registers. In the same or different examples, the total number of processor registers available in the electronic device may include central processing unit registers and co-processor registers. The method may further include, during execution of the first process, the operating system determining to context switch away from the first process, and saving the first number of processor registers used by the first process, leaving one or more processor registers unsaved when the context switch away from the first process is complete. In an example, saving the first number of processor registers used by the first process may include the operating system executing a context switch subroutine. In another example, saving the first number of processor registers used by the first process may include executing a single context switch instruction. The method may also include, during execution of a second process after determining to context switch away from the first process, the operating system determining to context switch to the first process, and restoring the first number of processor registers used by the first process, leaving one or more of the processor registers unrestored when the context switch to the first process is complete.

In the same or different examples, the method may include storing a value corresponding to the first number of processor registers in a data structure associated with the first process. The method may additionally include retrieving the value corresponding to the first number of processor registers from the data structure associated with the first process prior to saving the first number of processor registers used by the first process, and restoring the first number of processor registers used by the first process.

According to another example, a device is provided that may include a processor to execute a first process comprising a plurality of instructions, a plurality of processor registers to store data associated with one or more of the plurality of instructions, and a context switch instruction, executable by the processor, to move a contiguous set of the plurality of processor registers to or from a memory corresponding to a given memory address, wherein the contiguous set of the plurality of processor registers comprises at least two processor registers and is a proper subset of a total number of processor registers available in the device. In the same or different examples, the total number of processor registers available in the device may include integer registers and floating point registers. In the same or different examples, the total number of processor registers available in the device may include central processing unit registers and co-processor registers. In the same or different examples, the proper subset of the total number of processor registers available in the device may correspond to a maximum number of processor registers used by the first process. In the same or different examples, the device may include a register to store a value indicating how many processor registers are in the contiguous set of the plurality of processor registers, and the context switch instruction may use the stored value in the register to determine how many processor registers to move to or from the memory corresponding to the given memory address. In the same or different examples, the device may include a register to store a value corresponding to an address of a starting register of the contiguous set of the plurality of processor registers.

According to another example, a device is provided that may include a processor to execute a plurality of processes including a first process and a second process. The device may also include a memory. The device may further include a plurality of processor registers to store data associated with the first process of the plurality of processes when the processor is executing the first process of the plurality of processes and to store data associated with the second process of the plurality of processes when the processor is executing the second process of the plurality of processes. The device may also include a context save function to save, to the memory, a first number of processor registers of the plurality of processor registers, wherein the first number is at least two and is a proper subset of a total number of processor registers available in the device. In the same or different examples, the context save function may include instructions to save processor registers that are contiguously addressed. In the same or different examples, the proper subset of the total number of processor registers available in the device may correspond to a maximum number of processor registers used by the first process. In the same or different examples, the total number of processor registers available in the device may include central processing unit registers and co-processor registers. The device may also include a process data structure corresponding to the first process of the plurality of processes, the process data structure may include a context save tag corresponding to the context save function. The device may additionally include an operating system that may identify the context save function using the context save tag from the process data structure, may cause the processor to execute the identified context save function when context switching away from the first process, and may leave one or more processor registers of the plurality of processor registers unsaved when the context switching away from the first process is complete. In the same or different examples, the device may include a context restore function to restore, from the memory, the first number of processor registers of the plurality of processor registers. In the same or different examples, the process data structure may include a context restore tag corresponding to the context restore function, and the operating system may identify the context restore function using the context restore tag from the process data structure, may cause the processor to execute the identified context save function when context switching away from the first process, and may leave one or more processor registers of the plurality of processor registers unrestored when the context switching away from the second process to the first process is complete. In the same or different examples, the process data structure may include a count register to store a value corresponding to the first number of processor registers of the plurality of processor registers, and the context save function may include instructions to determine the number of processor registers to save based on the value of the count register. In the same or different examples, the process data structure may include an address register to store a value corresponding to the address of a starting register of the plurality of processor registers.

### BRIEF DESCRIPTION OF THE DRAWINGS

The figures illustrate examples of systems and methods for context switching between processes executing in an OS of an electronic device.

FIG. 1 illustrates one of various examples of context switching in an operating system.

FIG. 2 illustrates one of various examples of context switching in an operating system.

FIG. 3 illustrates one of various examples of an electronic device having a firmware solution for context switching in an operating system.

FIG. 4 illustrates a flow chart of an example method for an electronic device context switching in an OS.

FIG. 5 illustrates a flow chart of an example method for an electronic device context switching in an OS.

FIG. 6 illustrates one of various examples of an electronic device having a hardware solution for context switching in an operating system.

FIG. 7 illustrates one of various examples of an electronic device having a hardware solution for context switching in an operating system.

FIG. 8 illustrates one of various examples of an electronic device having a hardware solution for context switching in an operating system.

FIG. 9 illustrates one of various examples of an electronic device having a solution for context switching in an operating system.

FIG. 10 illustrates one of various examples of an electronic device having a solution for context switching in an operating system.

FIG. 11 illustrates one of various examples of an electronic device having a solution for context switching in an operating system.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The present disclosure provides systems and methods for efficient context switching between processes/threads executing in an OS of an electronic device.

A process is a program (made up of instructions) that may be executed by a processor on an electronic device. Processes are an integral part of any modern-day OS. The OS may allocate resources to processes, enable processes to share and exchange information, protect the resources of each process from other processes and enable synchronization among processes. Accordingly, the OS may maintain a data structure for each process, which may describes the state and resource ownership of that process, and which may enable the OS to exert control over each process. Processes may consist of many sub-processes, which introduces the concept of a thread. A thread may be viewed as a sub-process, i.e., a separate, independent sequence of execution within the code of one process.

The stopping of one process and starting (or restarting) of another process is called a context switch. Context switching may be part of the OS process management. A context switch may occur, for example, in response to a hardware interrupt or system call (i.e., a software interrupt). When a context switch occurs, the processor registers associated with the currently-running (i.e., outgoing or interrupted) process, may be saved to memory so that they may be restored when the process is resumed at a later time. (A processor register may be hardware located in a quickly accessible location available to a computer's central processing unit (CPU) or co-processor.)

Because general operating systems are written assuming no knowledge of the processes being switched between, all processor registers (CPU & co-processor) may be saved off during a context switch (e.g., by pushing them onto a stack frame). Before passing control back to the previous process (or the next process in line) the processor registers (CPU & co-processor) for that process may be restored, independent of how many were actually used by the process. Consequently, general operating systems may perform a full set of register stores (saving registers) and a full set of register loads (restoring registers) when context switching. As an example, if the hardware includes 32 processor registers, all 32 registers may be saved and restored during each context switch.

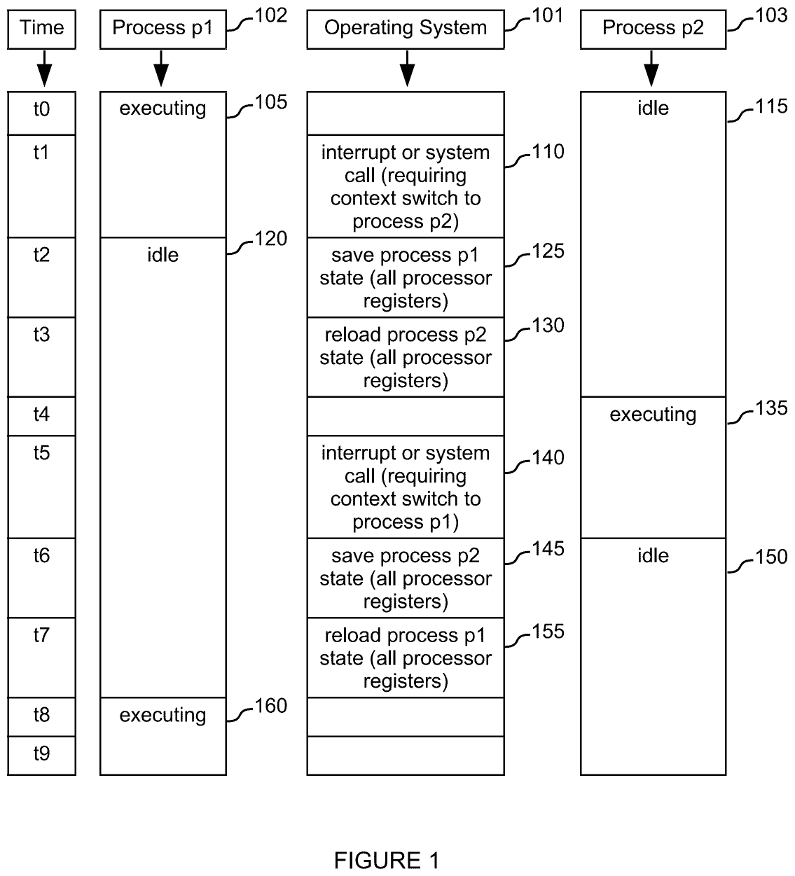

FIG. 1 illustrates one of various examples of context switching in OS 101. According to the example, OS 101 may manage context switching between two processes, process p1 102 and process p2 103. At time t0, process p1 102 may be executing in an electronic device, as depicted in 105. While process p1 102 is executing at time t0, process p2 103 may be idle, as depicted in 115. At time t1, OS 101 may encounter an interrupt or system call that requires context switching to process p2, as depicted in 110. In response, at time t2, process p1 102 may no longer execute and may become idle, as depicted in 120. Also at time t2, OS 101 may save the state of process p1 102, which may include saving all processor registers (which may include co-processor registers, if present), as depicted in 125. A processor register may also be called a CPU register or a working register, and is a quickly accessible memory location available to the processor (or co-processor) in an electronic device. At time t3, after all processor registers for process p1 102 have been saved, OS 101 may reload the state of process p2 103, which may include reloading all processor registers (which may include co-processor registers, if present), as depicted in 130. At time t4, after all processor registers for process p2 103 have been reloaded, process p2 103 may begin to execute in the electronic device, as depicted in 135.

At time t5, after process p2 103 has been executing, OS 101 may encounter an interrupt or system call that requires context switching to process p1, as depicted in 140. In response, at time t6, process p2 103 may no longer execute and may become idle, as depicted in 150. Also at time t6, OS 101 may save the state of process p2 103, which may include saving all processor registers (which may include co-processor registers, if present), as depicted in 145. At time t7, after all processor registers for process p2 103 have been saved, OS 101 may reload the state of process p1 102, which may include reloading all processor registers (which may include co-processor registers, if present), as depicted in 155. At time t8, after all processor registers for process p1 102 have been reloaded, process p1 102 may begin to execute in the electronic device, as depicted in 160.

As shown in the OS context switching flow of FIG. 1, the save and reload (restore) process state boxes (125, 130, 145, and 155) may include saving/loading all processor registers. In an example, processor registers may include CPU registers. In another example, processor registers may include CPU registers and co-processor registers. In some examples, processor registers may include integer registers. In some examples, processor registers may include floating-point registers. In an example, saving/loading all processor registers may include saving/loading sixteen 32-bit CPU registers and thirty-two 32-bit floating point registers.

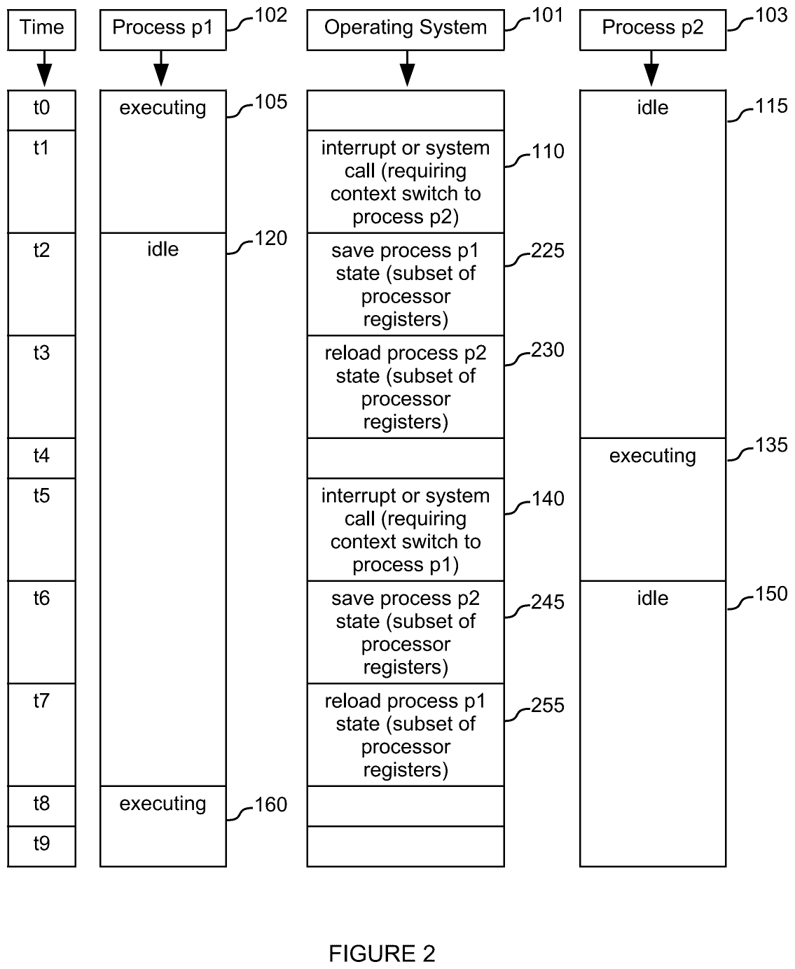

FIG. 2 illustrates one of various examples of context switching in OS 101. Similarly numbered elements in FIG. 2 are the same as described for FIG. 1. According to one example of the current disclosure, the context switching of FIG. 1 may be replaced with dynamic context switching that saves/restores a proper subset of processor registers instead of all processor registers, as depicted in save and reload (restore) process state boxes 225, 230, 245, and 255. The dynamic context switching may be based on a maximum number of processor registers used by the outgoing and incoming processes, which may avoid having to save/reload all processor registers (as depicted in FIG. 1, boxes 125, 130, 145, and 155). In an example, the dynamic context switching may be achieved with a context switch instruction that saves/restores a subset of processor registers. In an example, the dynamic context switching may be achieved by a single context switch instruction. In another example, the dynamic context switching may be achieved by more than one context switch instructions. In the same or different examples, the same instruction or instructions may execute for each context switch but with a custom number of registers that are saved and restored (e.g., fewer than all processor registers). These and other examples will be more fully described below.

According to an example, dynamic context switching may be based on a firmware solution that may include the following elements:
Post processor to scan an application and OS processes/threads to determine the CPU register and floating-point register usage.
Modification of the OS process data structure to include a link to a specific “per-process”/“per-thread” set of context switch functions that save and restore register usage.
Modification to the OS to dynamically choose which context switch functions to execute based on the linkage in the process data structure.
Post process lint type firmware to scan application processes/threads to group integer only and integer/floating point operations to minimize the register usage in high volume of time-sensitive applications.

In some examples, a firmware solution may result in a different context switch subroutine for each process/thread in the application. A firmware solution according to these examples may facilitate lower context switching and latency time by limiting the number of registers stored and loaded on each context switch. During the build process of an application, the firmware processes may be scanned for the number of CPU and co-processor processor registers used by that process/thread. A set of context save and restore functions/subroutines (“context-switch functions/subroutines”) may be built for that specific register use model. A process tag may be used in the OS to determine which context-switch function/subroutine would be associated with switching in and out of that process/thread. In one example of the firmware solution, a system level scan may also produce register use statistics for each process/thread/subroutine to aid the system architects to identify long latency threads and allow for corrective actions.

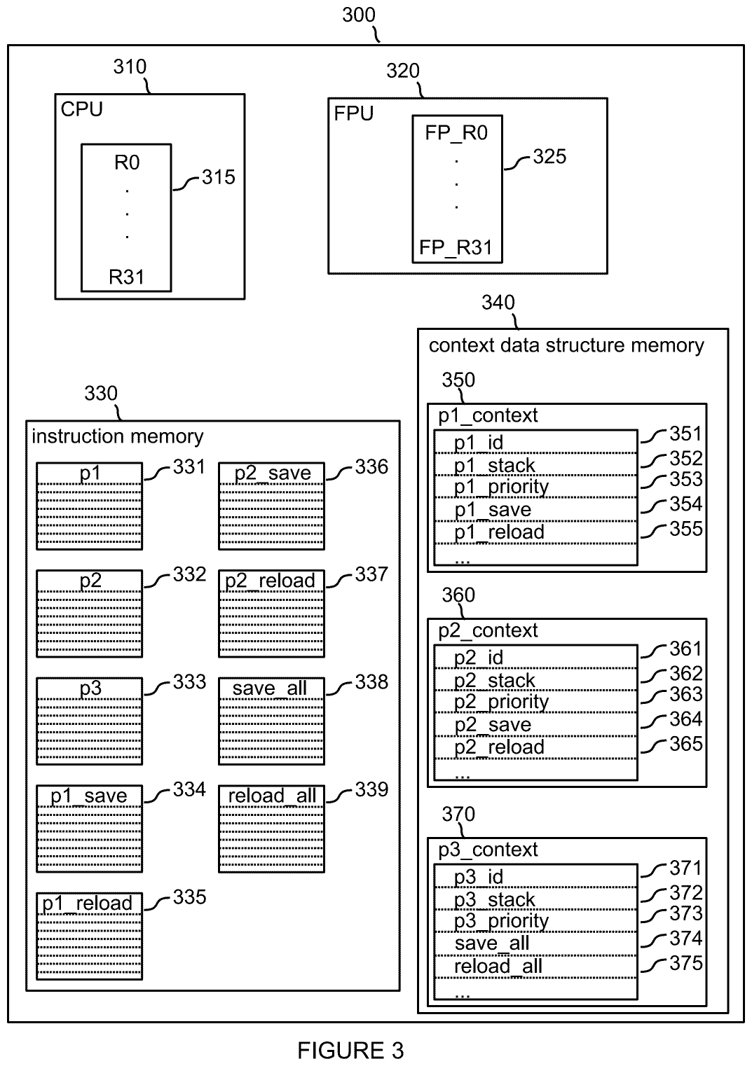

FIG. 3 illustrates one of various examples of an electronic device 300 having a firmware solution for context switching in OS 101. According to this example, electronic device 300 may include CPU 310 having thirty-two processor registers 315 (R0 through R31). Electronic device 300 may also include co-processor floating-point unit (FPU) 320 having thirty two co-processor registers 325 (FP_R0 through FP_R31). As illustrated, electronic device 300 may include instruction memory 330. Instruction memory 330 may be any type of volatile or non-volatile memory suitable for storing executable instructions. Instruction memory 330 may include the following:
Block 331 comprising instructions for process p1.
Block 332 comprising instructions for process p2.
Block 333 comprising instructions for process p3.
Block 334 comprising context-switch function/subroutine p1_save. Context-switch function/subroutine p1_save may correspond to the register use model of process p1 and may be executed by the OS when saving the context of process p1.
Block 335 comprising context-switch function/subroutine p1_reload. Context-switch function/subroutine p1_reload may correspond to the register use model of process p1 and may be executed by the OS when reloading the context of process p1.
Block 336 comprising context-switch function/subroutine p2_save. Context-switch function/subroutine p2_save may correspond to the register use model of process p2 and may be executed by the OS when saving the context of process p2.
Block 337 comprising context-switch function/subroutine p2_reload. Context-switch function/subroutine p2_reload may correspond to the register use model of process p2 and may be executed by the OS when reloading the context of process p2.
Block 338 comprising function/subroutine save_all. Function/subroutine save_all may operate to save all processor registers (e.g., processor registers 315 and co-processor registers 325) and may be executed by the OS when saving the context of a process that does not have a corresponding context-switch function.
Block 339 comprising function/subroutine reload_all. Function/subroutine reload_all may operate to reload all processor registers (e.g., processor registers 315 and co-processor registers 325) and may be executed by the OS when reloading the context of a process that does not have a corresponding context-switch function.

Blocks 331-339 may be contiguous or non-contiguous blocks in instruction memory 330. In the same or different examples, instructions within any of blocks 331-339 may be stored in contiguous or non-contiguous memory locations.

Electronic device 300 may include context data structure memory 340 where an OS executing on CPU 310 may store data structures containing information about a process's execution state. In the depicted example, context data structure memory 340 may include context data structure 350 for storing context information for process p1, context data structure 360 for storing context information for process p2, and context data structure 370 for storing context information for process p3. Each context data structure (350, 360, 370) may include information such as:
A process ID (p1_id 351, p2_id 361, p3_id 371), which may be a unique identifier for the process.
A process stack pointer (p1_stack 352, p2_stack 362, p3_stack 372), which may be the address pointing to the top of the process's call stack.
A process priority level (p1_priority 353, p2_priority 363, p3_priority 373), which may be the process's priority level for scheduling purposes.
A register save function/subroutine pointer (p1_save 354, p2_save 364, save_all 374), which may be an address of the function/subroutine used by the OS to save processor registers during a context switch (e.g., when exiting the process). In the example, p1_save 354 may correspond to the address of context-switch function/subroutine p1_save 334, p2_save 364 may correspond to the address of context-switch function/subroutine p2_save 336, and save_all 374 may correspond to the address of function/subroutine save_all 338.
A register reload function/subroutine pointer (p1_reload 355, p2_reload 365, reload_all 375), which may be an address of the function/subroutine used by the OS to reload processor registers during a context switch (e.g., when entering the process). In the example, p1_reload 355 may correspond to the address of context-switch function/subroutine p1_reload 335, p2_reload 365 may correspond to the address of context-switch function/subroutine p2_reload 337, and reload_all 375 may correspond to the address of function/subroutine reload_all 339.

In operation, the OS executing on electronic device 300 may use the information in context data structures 350, 360, and 370 to manage the different processes. In the example context switch illustrated in FIG. 2, OS 101 may use address pointer p1_save 354 at time t2 to execute context-switch function/subroutine p1_save 334 to save process p1 register state (block 225). Thus, instead of saving thirty-two processor registers 315 and thirty-two co-processor registers 325, OS 101 may save the registers corresponding to the register use model of process p1, which may be fewer than the total number of available registers (e.g., registers in 315 and 325). In the example context switch illustrated in FIG. 2, OS 101 may use address pointer p2_reload 365 at time t3 to execute context-switch function/subroutine p2_reload 337 to reload process p2 state (block 230). Thus, instead of reloading thirty-two processor registers 315 and thirty-two co-processor registers 325, OS 101 may reload the registers corresponding to the register use model of process p2, which may be fewer than the total number of available registers (e.g., registers in 315 and 325). Similarly, OS 101 may use address pointer p2_save 364 at time t6 to execute context-switch function/subroutine p2_save 336 to save process p2 register state (block 245) and may use address pointer p1_reload 355 at time t7 to execute context-switch function/subroutine p1_reload 335 to reload process p1 register state (block 255).

TABLE 1 illustrates example register use models for example processes p1 and p2.

TABLE 1

| Process | Processor Registers Used | Co-Processor Registers Used |
|---|---|---|
| p1 | R0, R5, R6, R7, R9, R12, R15 | — |
| p2 | R0, R2, R3, R6, R7 | FP_R1, FP_R2, FP_R3 |

For the example shown in TABLE 1, context switch function/subroutines p1_save 334, p1_reload 335, p2_save, 336, and p2_reload 337 may operate according to the following pseudo-code:

```
function p1_save {
  store R0;
  store R5;
  store R6;
  store R7;
  store R9;
  store R12;
  store R15;
}
function p1_reload {
  load R0;
  load R5;
  load R6;
  load R7;
  load R9;
  load R12;
  load R15;
}
function p2_save {
  store R0;
  store R2;
  store R3;
  store R6;
  store R7;
  store FP_R1;
  store FP_R2;
  store FP_R3;
}
function p2_reload {
  load R0;
  load R2;
  load R3;
  load R6;
  load R7;
  load FP_R1;
  load FP_R2;
  load FP_R3;
}
```

Context data structures 350, 360, and 370 may contain process information in addition to that depicted in FIG. 3 including, without limitation, processor register values, processor local storage, signal masks, program counter register, and status register, among others.

Although FIG. 3 illustrates various components of an electronic device 300 having a firmware solution for context switching in OS 101, other example devices may include more or fewer components. In additional examples, specific components of an electronic device having a firmware solution for context switching in an operating system may include features in addition to those described above or may omit some of the features described above.

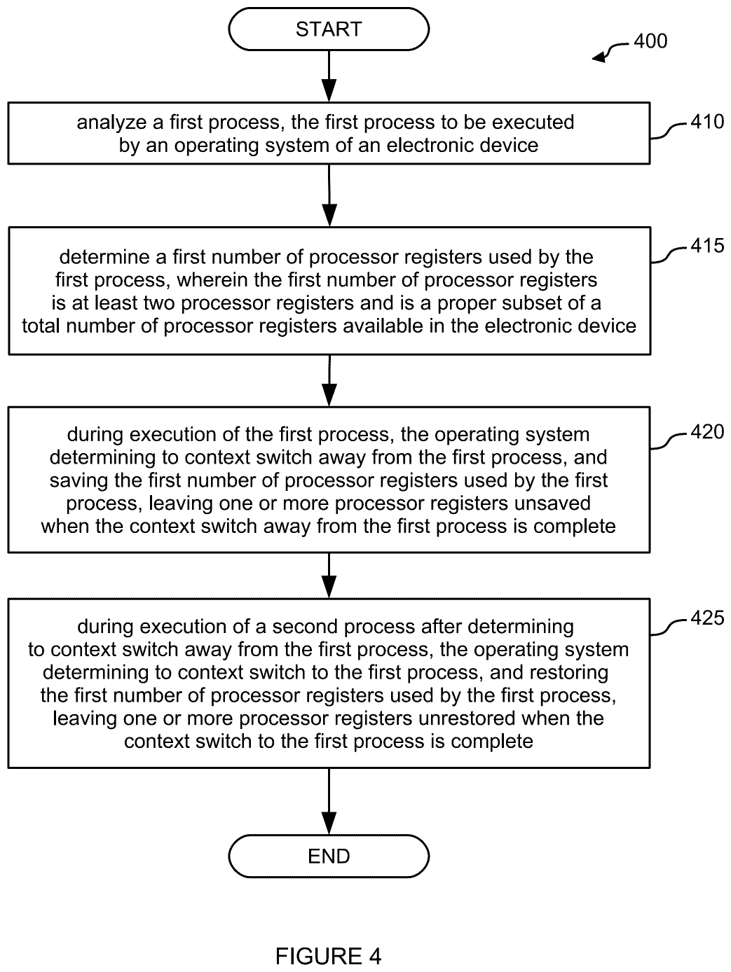

FIG. 4 illustrates a flow chart of an example method 400 for an electronic device 300 context switching in an OS 101. According to one example, method 400 may begin at block 410. Teachings of the present disclosure may be implemented in a variety of configurations of OS 101. As such, the initialization point for method 400 and the order of 410-425 comprising method 400 may depend on the implementation chosen.

At block 410, a first process to be executed by an OS of an electronic device may be analyzed. In an example, the first process may be represented by object code to be executed by OS 101, and the object code may be analyzed by a utility program running on an electronic device (e.g., lint tool, objdump utility (available on linux), among others). In another example, the first process may be represented by assembly code and may be analyzed by an analyzer utility. At block 415, the first number of processor registers used by the first process may be determined. In an example, the first number of processor registers may be at least two processor registers and may be a proper subset of a total number of processor registers available in the electronic device. (A proper subset is fewer than the total number of processor registers available in the electronic device.) With reference to example electronic device 300 (FIG. 3), a proper subset of the total number of processor registers available in the electronic device may refer to a proper subset of processor registers 315 (e.g., R0, R3, R6, R7), a proper subset of co-processor registers 325 (e.g., FP_R1, FP_R4, FP_R5, FP_R6, FP_R9, FP_R20), or a proper subset of both processor registers 315 and co-processor registers 325 (e.g., R0, R6, R7, R9, R10, R11, R12, FP_R0, FP_R1). In an example, processor registers 315 may be integer registers and co-processor registers 325 may be floating point registers. In other examples, processor registers and co-processor registers may be any combination of integer, floating point, vector, or other registers.

At block 420, during execution of the first process, the OS may determine to context switch away from the first process and save the first number of processor registers used by the first process, leaving one or more processor registers unsaved when the context switch away from the first process is complete. Examples of times when the OS may determine to context switch away from the first process include during multitasking, time slicing in preemptive scheduling, process blocking (I/O or resource waiting), giving way to a higher priority process, interrupt handling, voluntary process yielding, memory swapping, and memory paging, among others. Because the OS saves the first number of processor registers (and not all available processor registers), the context switch may be performed more quickly than if the OS saves all processor registers (e.g., using function/subroutine save_all 338). In an example, the saving the first number of processor registers used by the first process may comprise the operating system executing a context switch subroutine (e.g., p1_save 334, p2_save 336). In another example, the saving the first number of processor registers used by the first process may comprise executing a single context switch instruction (e.g., CNTX_STORE, MOVW, both described below). In an example, the proper subset of the total number of processor registers available in the electronic device may comprise processor registers that are contiguously addressed (e.g., R0, R1, R2, R3, R4, R5 in processor registers 315; FP_R11, FP_R12, FP_R13 in co-processor registers 325).

At block 425, during execution of a second process after determining to context switch away from the first process, the OS may determine to context switch to the first process, and restore the first number of processor registers used by the first process, leaving one or more processor registers unrestored when the context switch to the first process is complete. Examples of times when the OS may determine to context switch to the first process include during multitasking, time slicing in preemptive scheduling, process blocking (I/O or resource waiting), giving way to a higher priority process (e.g., first process is higher priority than the second process), interrupt handling, voluntary process yielding, memory swapping, and memory paging, among others. Because the OS restores the first number of processor registers (and not all available processor registers), the context switch may be performed more quickly than if the OS restores all processor registers (e.g., using function/subroutine reload_all 339). In an example, the restoring the first number of processor registers used by the first process may comprise the operating system executing a context switch subroutine (e.g., p1_reload 335, p2_reload 337). In another example, the saving the first number of processor registers used by the first process may comprise executing a single context switch instruction (e.g., CNTX_STORE, MOVW, both described below).

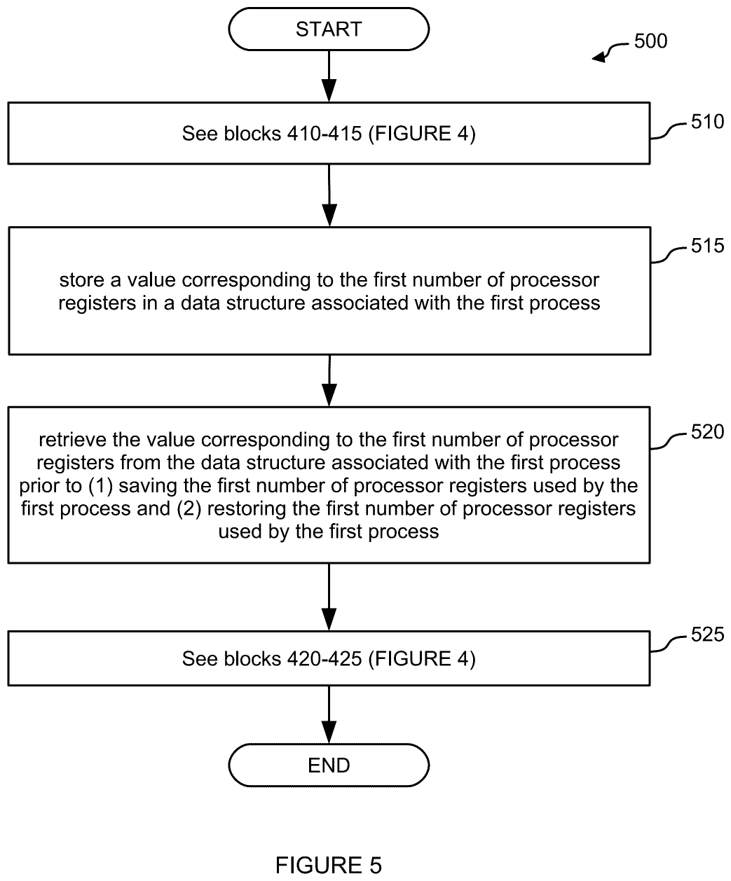

Although FIG. 4 discloses a particular number of operations related to method 400, method 400 may be executed with greater or fewer operations than those depicted in FIG. 4. For example, after block 415, method 400 may continue with additional operations illustrated in FIG. 5. In addition, although FIG. 4 discloses a certain order of operations to be taken with respect to method 400, the operations comprising method 400 may be completed in any suitable order.

FIG. 5 illustrates a flow chart of an example method 500 for an electronic device 300 context switching in an OS 101. According to one example, method 500 may begin at block 510. Teachings of the present disclosure may be implemented in a variety of configurations of OS 101. As such, the initialization point for method 500 and the order of 510-525 comprising method 500 may depend on the implementation chosen.

According to an example, block 510 may be the same as blocks 410-415 in FIG. 4. At block 515, a value corresponding to the first number of processor registers may be stored in a data structure associated with the first process. In an example, OS 101 may store the value in a context data structure (e.g., 350, 360, and 370). In other examples, the value may be stored by any other suitable means (e.g., firmware, user code, and boot code, among others). At block 520, the value corresponding to the first number of processor registers may be retrieved from the data structure associated with the first process (e.g., by OS 101) prior to (1) saving the first number of processor registers used by the first process and (2) restoring the first number of processor registers used by the first process. In an example, OS 101 may use the value corresponding to the first number of processor registers to facilitate the saving and restoring the first number of processor registers. For example, if the value corresponding to the first number of processor registers is five (5), OS 101 may save/restore lowest-ordered processor registers R0, R1, R2, R3, R4 in processor registers 315 during context switching. In another example where the value corresponding to the first number of processor registers is five (5), OS 101 may save/restore highest-ordered processor registers R32, R31, R30, R29, and R28 in processor registers 315 during context switching. In yet another example where the value corresponding to the first number of processor registers is five (5), OS 101 may save/restore processor registers other than lowest- or highest-ordered, e.g., R8, R9, R10, R11, and R12 in processor registers 315 during context switching. This last example may be accomplished through the use of a starting register number (here, R8) that may be provided in addition to the first number of processor registers. In an example, a starting register number may be saved in context data structure corresponding to the process (e.g., 350, 360, 370). While the previous examples involve saving/restoring contiguously numbered processor registers, other examples may use different techniques appropriate for the architecture and/or register use model (e.g., saving/restoring five non-contiguously numbered processor registers).

In another example where electronic device 300 includes processor registers 315 and co-processor registers 325, if the value corresponding to the first number of processor registers is five (5), OS 101 may save/restore five processor registers R0, R1, R2, R3, and R4 in processor registers 315 and co-processor registers FP_R0, FP_R1, FP_R2, FP_R3, and FP_R4 in co-processor registers 325 during context switching. In yet another example, the data structure associated with the first process may include a value corresponding to the first number of processor registers 315 to be saved/restored during context switching and a separate value corresponding to a number of co-processor registers 325 to be saved/restored during context switching. In an example, the value corresponding to the first number of processor registers 315 may be the same as the value corresponding to the number of co-processor registers 325. In a further example, the value corresponding to the first number of processor registers 315 may differ from the value corresponding to the number of co-processor registers 325. Other examples may use different techniques appropriate for the architecture and/or register use model (e.g., saving/restoring five non-contiguously numbered processor and co-processor registers, saving/restoring five processor/co-processor registers R32-R28/FP_R32-FP_R28, among others).

The processor registers to be saved/restored during context switching according to the above examples may depend on the particular architecture(s) of electronic device 300, OS 101, and software/firmware running on electronic device 300. In an example, a firmware solution may restrict the use of registers in a process (and its sub-functions) to allow for one set of reduced register save and load context switch functions. For example, processes may be restricted to use eight (8) out of the total of thirty-two (32) processor registers, and the context switch functions will save/restore eight (8) registers. In another example, processes may be restricted to use eight (8) out of the total of thirty-two (32) processor registers and five (5) out of the total of thirty-two (32) co-processor registers, and the context switch functions will save/restore eight (8) processor registers and five (5) co-processor registers.

In another example, a firmware solution may include enhancing the thread creation process to publish the number of processor registers allowed for that process, and publish this into the process/thread data structure of the OS (e.g., context data structure 350, 360, 370). At context switch time, the appropriate limited context switch may be called, and the process/thread data structure may be updated to point to the correct restore context function. In an example where the processor registers are guaranteed to be in linear contiguous order (e.g., processor registers R0-R7, not, e.g., processor registers R0, R2, R4, R5, R6, R7, R8, R10), the context switch could be written to dynamically save/restore the correct number of registers in a dynamic context switch function. In an example, a dynamic context switch function may use a starting register number (e.g., R0), a starting register save address (or stack pointer), and a total register count to save a proper subset of the total number of available processor registers at context switch time.

In another example, a hardware assisted method may result in one generic context switch subroutine and therefore reduce the effort needed for firmware validation. In this example, a single context switch instruction may move a contiguous set of registers to/from a given memory (or implied stack) address starting at a given register defined in a processor register or the process/thread data structure. In an example, the instruction may imply a PUSH (save) or POP (restore) based on addressing mode assuming conventional stack structure. In an example, the starting address register may be updated during each iteration.

In the hardware-assisted example, the compiler/post-processor firmware may construct the context data structure (e.g., 350, 360, 370 maintained by the OS) based on scanning the target process to determine register usage. For example, if scanning the target process determined the process used a maximum of eight (8) processor registers, the compiler/post-processor may construct the context switch data structure so that a maximum of eight (8) processor registers are saved/restored for that process. In the same or different examples, the compiler may also assure the register usage was contiguous (e.g., ensure the process uses processor registers 0-7, not, e.g., registers 0, 2, 4, 5, 6, 7, 8 10). In the hardware-assisted example, the context switching data structure would contain the data to populate the context switch instruction.

In an example, assembler instructions may be added and supported by hardware and OS 101 on electronic device 300 to facilitate a dynamic context switch process. The following assembler instructions would allow a fully dynamic context store operation at runtime:
CNTX_STORE START, COUNT, SP_REG
   START: starting register number to push on stack
   COUNT: number of registers to push
   SP_REG: stack pointer register to use (with auto decrement)
CNTX_LOAD START, COUNT, SP_REG
   START: starting register number to pop off stack
   COUNT: number of registers to pop
   SP_REG: stack pointer register to use (with auto increment)

Another example assembler instruction is provided using Microchip's DSPIC microcontroller (e.g., DSPIC33A). In this example, a new MOVW assembler instruction may be defined as provided in TABLE 2.

TABLE 2

| MOVW | Move Sequential W-reg To/From Stack |
|---|---|
| Syntax: | {label:} MOVW lit4, [Wd++] \| [−−Ws] |
| Operands: | Ws: [WO . . . W15]; |
| | Wd: [WO . . . W15]; |
| | lit4: [0 . . . 14] |
| Description: | Iterative sequential W-reg move to or from a LIFO stack data structure (or |
| | data memory). Instruction to be executed from within a REPEAT loop. |
| | Integer lit4 determines the first W-reg to move. It is written to |
| | SR.MOVW[3:0] during the first REPEAT iteration where it is then used to |
| | record subsequent register selections (such that the REPEAT loop may be |
| | interrupted at any iteration boundary). |
| | For a stack push operation ([Wd++]), first register moved will be Wlit4, |
| | second register will be Wlit4 + 1, . . . , one register per REPEAT iteration. |
| | Increment SR.MOVW[3:0] during each iteration to select the W-reg to |
| | move during the next REPEAT iteration. |
| | For a stack pop operation ([−−Ws]), first register moved will be Wlit4, |
| | second register will be Wlit4 − 1, . . . , one register per REPEAT iteration. |
| | Decrement SR.MOVW[3:0] during each iteration to select the W-reg to |
| | move during the next REPEAT iteration. |
| | Should SR.MOVW[3:0] = 4′b1111 at the start of a REPEAT iteration, the |
| | user has inadvertently defined more REPEAT iterations than there are |
| | registers to move. This and all subsequent iterations will execute as NOPs. |
| | No error is flagged. |
| | The ‘k’ bits select the first W-reg to move. |
| | The ‘s' bits select the source register. |
| | The ‘d’ bits select the destination register. |
| | The ‘p’ bits select the source addressing mode. |
| | The ‘q’ bits select the destination addressing mode. |

The following pseudo-code illustrates an example use of the MOVW instruction:

| | | |
|---|---|---|
| REPEAT | Wn | ; Wn previously set to 5 |
| MOVW | [w15++] | ; push w8 . . . w13 (6 regs) |
| | | ; use of post inc addressing indicates |
| | | ; PUSH and first reg = SR. START |
| | (task body) | |
| REPEAT | Wn | ; Wn previously set to 5 |
| MOVW | [−−w15] | ; pop w13 . . . w8 (6 regs) |
| | | ; use of pre dec addressing indicates |
| | | ; POP and first reg = SR.START |

The REPEAT instruction currently exists. Register SR.START (i.e., the first register to move) may be part of the process/thread data structure (e.g., context data structure 350, 360, 370) or stored in other processor-accessible memory. According to this example, the new MOVW instruction may execute within the existing REPEAT loop framework so is interruptible on each iteration boundary. In other examples, the MOVW instruction may be made to be atomic so that the processor registers are saved/restored without interruption. For example, an atomic MOVW instruction may not require the REPEAT loop framework, and may be a single instruction that performs a given number of processor register saves/reloads. In the same or different examples, the first register to move (SR.START) and number of subsequent registers to move (REPEAT count value) may be dynamically defined (register direct or indirect values). In an example, the dynamic definition may include register assignments for working processor registers (e.g., 315 in FIG. 3) and any co-processor processor registers (e.g., floating-point registers 325 in FIG. 3).

According to the above examples, the following benefits may be achieved:
Use with existing OS/applications to provide a consistent way to reduce the overhead of event/interrupt handling.
Direct usage in most/all embedded applications that use a context switching environment or OS.
Separation of CPU/co-processor instruction set architecture additions for scalability.
Lower application/interrupt response time.
Reduce code complexity and therefore increases firmware reliability.
Improve performance.
Allow for fewer changes to OS with changes to CPU/co-processor.
Simplify OS firmware.
Bi-directional register stack movement for firmware flexibility.

Following block 520, method 500 may proceed to block 525, which may be the same as blocks 420-425 in FIG. 4. Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

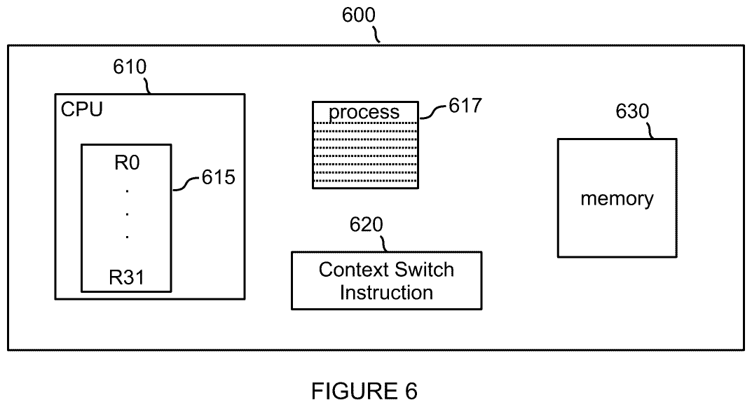

FIG. 6 illustrates one of various examples of an electronic device 600 having a hardware solution for context switching in OS 101. According to this example, electronic device 600 may include CPU 610 having thirty-two processor registers 615 (R0 through R31). In an example, processor registers 615 may include integer registers, floating point registers, or both integer registers and floating point registers. In the same or different example, processor registers 615 may include CPU registers, co-processor registers, or both CPU registers and co-processor registers. As illustrated, electronic device 600 may include memory 630. Memory 630 may be any type of volatile or non-volatile memory suitable for storing information such as data or instructions. Electronic device 600 may also include context switch instruction 620, which may be the same or similar to instructions CNTX_STORE, CNTX_LOAD, and MOVW (described above). According to this example, electronic device 600 may include hardware that performs the functions of context switch instruction 620. For example, CPU 610 may execute first process 617 comprising a plurality of instructions, and CPU 610 may have hardware to perform the functions of context switch instruction 620. In an example, first process 617 may be instructions that may be stored in contiguous or non-contiguous memory locations accessible to CPU 610. In an example, context switch instruction 620 may be executed by CPU 610, and may move a contiguous set of the plurality of processor registers 615 to or from memory 630 corresponding to a given memory address, wherein the contiguous set of the plurality of processor registers comprises at least two processor registers and is a proper subset of a total number of processor registers (32) available in electronic device 600. In an example, the proper subset of the total number of processor registers available in electronic device 600 may correspond to a maximum number of processor registers used by first process 617.

Although FIG. 6 illustrates various components of an electronic device 600 having a hardware solution for context switching in OS 101, other example devices may include more or fewer components. In additional examples, specific components of an electronic device having a hardware solution for context switching in an operating system may include features in addition to those described above or may omit some of the features described above.

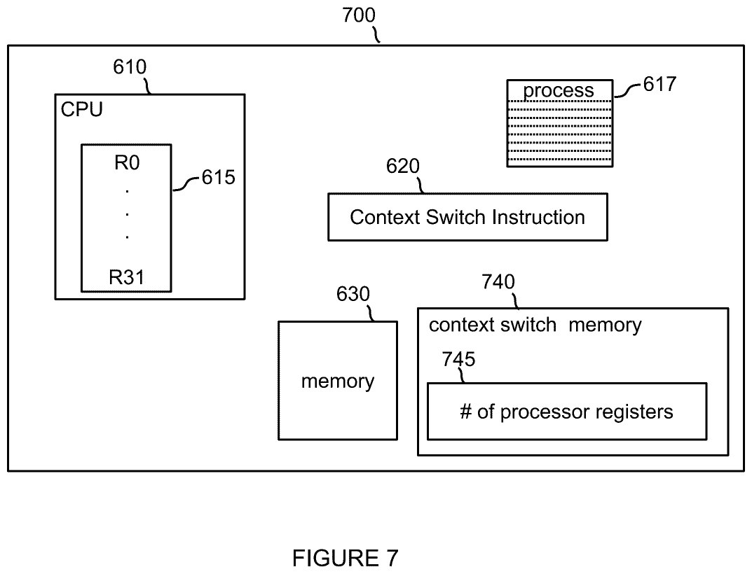

FIG. 7 illustrates one of various examples of an electronic device 700 having a hardware solution for context switching in OS 101. According to this example, electronic device 700 may include items 610, 615, 617, 620, and 630, which may be the same as described for FIG. 6. In addition, electronic device 700 may include context switch memory 740. Context switch memory 740 may be a register or other memory accessible to CPU 610. In this example, context switch memory 740 may store a value 745 indicating how many processor registers 615 are in the contiguous set of the plurality of processor registers, and the context switch instruction 620 may use stored value 745 in context switch memory 740 to determine how many processor registers 615 to move to or from the memory 630 corresponding to the given memory address.

Although FIG. 7 illustrates various components of an electronic device 700 having a hardware solution for context switching in OS 101, other example devices may include more or fewer components. In additional examples, specific components of an electronic device having a hardware solution for context switching in an operating system may include features in addition to those described above or may omit some of the features described above.

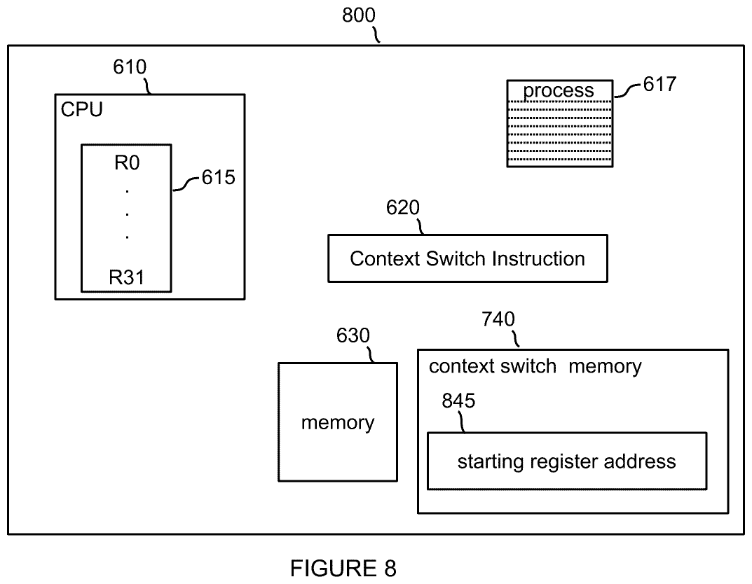

FIG. 8 illustrates one of various examples of an electronic device 800 having a hardware solution for context switching in OS 101. According to this example, electronic device 800 may include items 610, 615, 617, 620, and 630, which may be the same as described for FIG. 6. Electronic device 800 may also include context switch memory 740, which may be the same as described for FIG. 7. In addition, context switch memory 740 may store a value 845 corresponding to an address of a starting register of the contiguous set of the plurality of processor registers 615. In an example, value 845 may be the address of the starting register of the contiguous set of the plurality of processor registers 615. In another example, value 845 may be an offset or other value that corresponds to the address of the starting register of the contiguous set of the plurality of processor registers 615.

Although FIG. 8 illustrates various components of an electronic device 800 having a hardware solution for context switching in OS 101, other example devices may include more or fewer components. In additional examples, specific components of an electronic device having a hardware solution for context switching in an operating system may include features in addition to those described above or may omit some of the features described above.

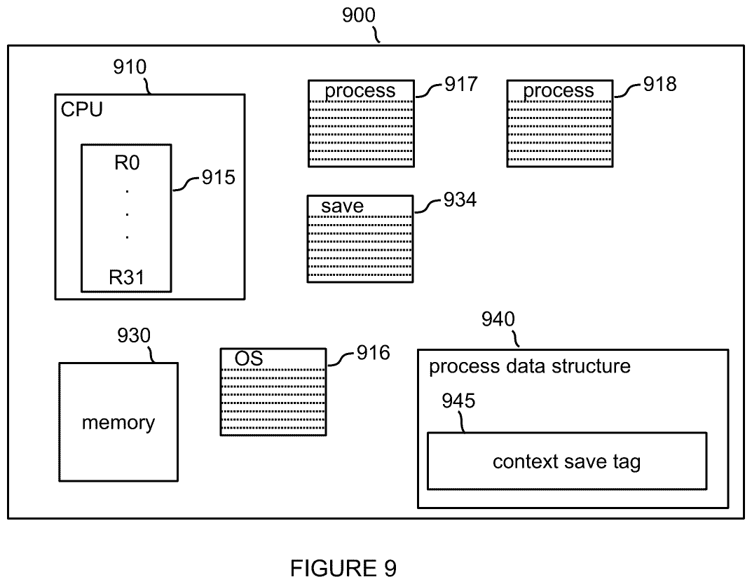

FIG. 9 illustrates one of various examples of an electronic device 900 having a solution for context switching in an operating system 916. According to this example, electronic device 900 may include CPU 910 having thirty-two processor registers 915 (R0 through R31). In an example, processor registers 915 may include integer registers, floating point registers, or both integer registers and floating point registers. In the same or different example, processor registers 915 may include CPU registers, co-processor registers, or both CPU registers and co-processor registers. As illustrated, electronic device 900 may include memory 930. Memory 930 may be any type of volatile or non-volatile memory suitable for storing information such as data or instructions.

Electronic device 900 may include first process 917 and second process 918, which may be made up of a plurality of instructions. For example, CPU 910 may execute first process 917 comprising a plurality of instructions. In the same or different examples, CPU 910 may execute second process 918 comprising a plurality of instructions. First process 917 and second process 918 may be instructions stored in contiguous or non-contiguous memory locations accessible to CPU 910. Processor registers 915 may store data associated with first process 917 when CPU 910 is executing first process 917. Processor registers 915 may store data associated with second process 918 when CPU 910 is executing second process 918.

Electronic device 900 may also include context save function 934, which may be the same or similar to context switch subroutine (e.g., p1_save 334, p2_save 336 in FIG. 3). In an example, context save function 934 may be the same or similar to instructions CNTX_STORE and MOVW (described above). Electronic device 900 may include hardware that performs context save function 934. In operation, context save function 934 may save, to memory 930, a first number of processor registers of the plurality of processor registers 915, wherein the first number is at least two and is a proper subset of a total number of processor registers 915 available in electronic device 900. In an example, the proper subset of the total number of processor registers available in electronic device 900 may correspond to a maximum number of processor registers used by first process 917. In the same or different examples, context save function 934 may include instructions to save processor registers 915 that are contiguously addressed (e.g., R0, R1, R2, R3, R4).

Electronic device 900 may include process data structure 940. Process data structure 940 may correspond to first process 917 and include context save tag 945. Context save tag 945 may correspond to context save function 934. In an example, context save tag 945 may be the address of context save function 934. In another example, context save tag 945 may be an offset or other value that corresponds to the address of context save function 934.

Electronic device 900 may include OS 916. OS 916 may be configured to identify context save function 934 using context save tag 945 from process data structure 940. OS 916 may also be configured to cause CPU 910 to execute context save function 934 when context switching away from first process 917. OS 916 may also be configured to leave one or more processor registers of the plurality of processor registers 915 unsaved when the context switch away from first process 917 is complete. Because OS 916 is configured to leave one or more processor registers of the plurality of processor registers 915 unsaved, the context switch may be performed more quickly than if OS 916 were to save all processor registers (e.g., using function/subroutine save_all 338 (FIG. 3)).

Although FIG. 9 illustrates various components of an electronic device 900 having a solution for context switching in operating system 916, other example devices may include more or fewer components. In additional examples, specific components of an electronic device having a solution for context switching in an operating system may include features in addition to those described above or may omit some of the features described above.

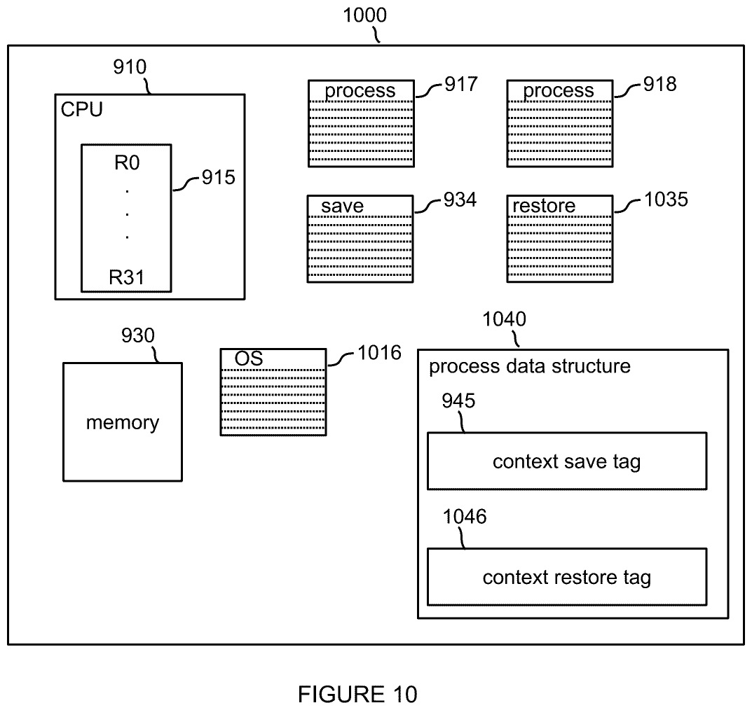

FIG. 10 illustrates one of various examples of an electronic device 1000 having a solution for context switching in an operating system 916. According to this example, electronic device 1000 may include items 910, 915, 917, 918, 930, 934, and 945, which may be the same as described for FIG. 9. Electronic device 1000 may also include context restore function 1035, which may be the same or similar to context switch subroutine (e.g., p1_reload 335, p2_reload 337 in FIG. 3). In an example, context restore function 1035 may be the same or similar to instructions CNTX_LOAD and MOVW (described above). Electronic device 1000 may include hardware that performs context restore function 1035. In operation, context restore function 1035 may restore, from memory 930, a first number of processor registers of the plurality of processor registers 915. The first number of processor registers may be at least two and is a proper subset of a total number of processor registers 915 available in electronic device 1000. In an example, the proper subset of the total number of processor registers available in electronic device 1000 may correspond to a maximum number of processor registers used by first process 917.

Electronic device 1000 may include process data structure 1040. Process data structure 1040 may correspond to first process 917 and include context save tag 945 and context restore tag 1046. Context restore tag 1046 may correspond to context restore function 1035. In an example, context restore tag 1046 may be the address of context restore function 1035. In another example, context restore tag 1046 may be an offset or other value that corresponds to the address of context restore function 1035.

Electronic device 1000 may include OS 1016. OS 1016 may have the capabilities described for OS 916 in FIG. 9. OS 1016 may additionally be configured to identify context restore function 1035 using context restore tag 1046 from process data structure 1040. OS 1016 may cause CPU 916 to execute context restore function 1035 when context switching away from second process 918 to first process 917. OS 1016 may leave one or more processor registers of the plurality of processor registers 915 unrestored when the context switch away from second process 918 to first process 917 is complete. Because OS 1016 is configured to leave one or more processor registers of the plurality of processor registers 915 unrestored, the context switch may be performed more quickly than if OS 1016 were to restore all processor registers (e.g., using function/subroutine reload_all 339 (FIG. 3)).

Although FIG. 10 illustrates various components of an electronic device 1000 having a solution for context switching in OS 1016, other example devices may include more or fewer components. In additional examples, specific components of an electronic device having a solution for context switching in an operating system may include features in addition to those described above or may omit some of the features described above.

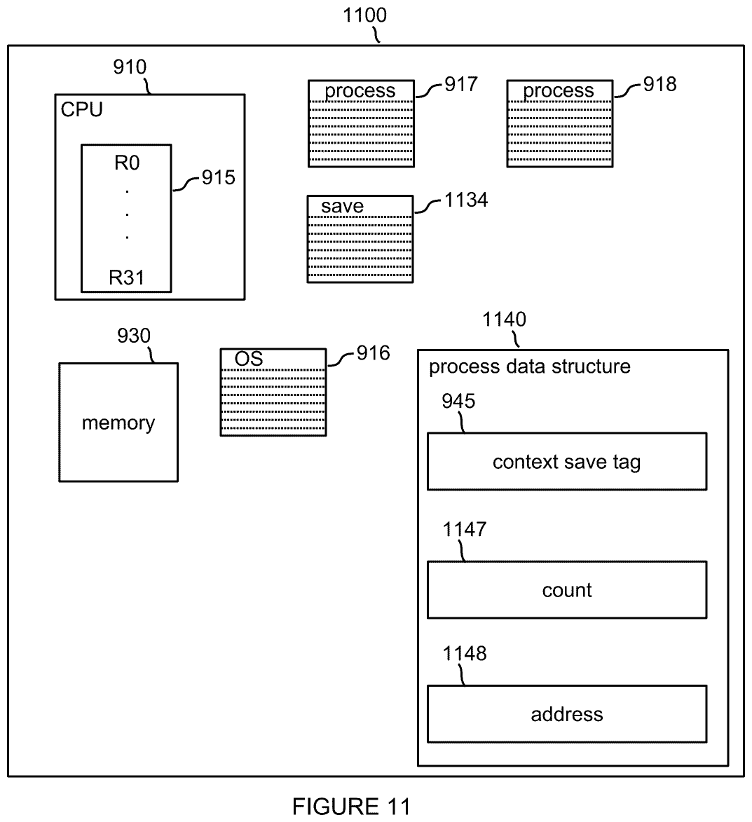

FIG. 11 illustrates one of various examples of an electronic device 1100 having a solution for context switching in OS 916. According to this example, electronic device 1100 may include items 910, 915, 916, 917, 918, 930, and 945, which may be the same as described for FIG. 9. Electronic device 1100 may also include process data structure 1140. Process data structure 1140 may correspond to first process 917 and include one or more of context save tag 945, count field 1147, and address field 1148. Count field 1147 may be configured to store a value corresponding to the first number of processor registers of the plurality of processor registers 915. Address field 1148 may be configured to store a value corresponding to the address of a starting register of the plurality of processor registers 915.

Electronic device 1100 may also include context save function 1134, which may be the same or similar to context switch subroutine (e.g., p1_save 334, p2_save 336 in FIG. 3). In an example, context save function 1134 may be the same or similar to instructions CNTX_STORE and MOVW (described above). Electronic device 1100 may include hardware that performs context save function 1134. In operation, context save function 1134 may save to memory 930, a first number of processor registers of the plurality of processor registers 915, wherein the first number is at least two and is a proper subset of a total number of processor registers 915 available in electronic device 1100. In an example, the proper subset of the total number of processor registers available in electronic device 1100 may correspond to a maximum number of processor registers used by first process 917. In the same or different examples, context save function 1134 may include instructions to save processor registers 915 that are contiguously addressed (e.g., R0, R1, R2, R3, R4). In the same or different examples, context save function 1134 may include instructions to determine the number of processor registers to save based on the value of count field 1147. In the same or different examples, context save function 1134 may include instructions to save at least the processor register corresponding to the value stored in address field 1148 (e.g., the address of a starting register of the plurality of processor registers 915).

Although FIG. 11 illustrates various components of an electronic device 1100 having a solution for context switching in OS 916, other example devices may include more or fewer components. In additional examples, specific components of an electronic device having a solution for context switching in an operating system may include features in addition to those described above or may omit some of the features described above.

Changes may be made to the present disclosure without departing from the spirit and scope of the disclosure.

1. A method, comprising:
analyzing a first process, the first process to be executed by an operating system of an electronic device;
determining a first number of processor registers used by the first process, wherein the first number of processor registers is at least two processor registers and is a proper subset of a total number of processor registers available in the electronic device;
during execution of the first process, the operating system:
determining to context switch away from the first process, and
saving the first number of processor registers used by the first process, leaving one or more processor registers unsaved when the context switch away from the first process is complete; and
during execution of a second process after determining to context switch away from the first process, the operating system:
determining to context switch to the first process, and
restoring the first number of processor registers used by the first process, leaving one or more processor registers unrestored when the context switch to the first process is complete.

2. The method of claim 1, wherein saving the first number of processor registers used by the first process comprises the operating system executing a context switch subroutine.

3. The method of claim 1, wherein saving the first number of processor registers used by the first process comprises executing a single context switch instruction.

4. The method of claim 1, wherein the proper subset of the total number of processor registers available in the electronic device comprises processor registers that are contiguously addressed.

5. The method of claim 1, comprising:
storing a value corresponding to the first number of processor registers in a data structure associated with the first process; and
retrieving the value corresponding to the first number of processor registers from the data structure associated with the first process prior to:
saving the first number of processor registers used by the first process, and
restoring the first number of processor registers used by the first process.

6. The method of claim 1, wherein the total number of processor registers available in the electronic device includes integer registers and floating point registers.

7. The method of claim 1, wherein the total number of processor registers available in the electronic device includes central processing unit registers and co-processor registers.

8. A device, comprising:
a processor to execute a first process comprising a plurality of instructions;
a plurality of processor registers to store data associated with one or more of the plurality of instructions; and
a context switch instruction, executable by the processor, to move a contiguous set of the plurality of processor registers to or from a memory corresponding to a given memory address, wherein the contiguous set of the plurality of processor registers comprises at least two processor registers and is a proper subset of a total number of processor registers available in the device.

9. The device of claim 8, comprising:
a context switch memory to store a value indicating how many processor registers are in the contiguous set of the plurality of processor registers, and
the context switch instruction to use the stored value in the context switch memory to determine how many processor registers to move to or from the memory corresponding to the given memory address.

10. The device of claim 8, wherein the total number of processor registers available in the device includes integer registers and floating point registers.

11. The device of claim 8, wherein the total number of processor registers available in the device includes central processing unit registers and co-processor registers.

12. The device of claim 8, comprising:
a context switch memory to store a value corresponding to an address of a starting register of the contiguous set of the plurality of processor registers.

13. The device of claim 8, wherein the proper subset of the total number of processor registers available in the device corresponds to a maximum number of processor registers used by the first process.

14. A device, comprising:
a processor to execute a plurality of processes including a first process and a second process;
a memory;
a plurality of processor registers to store data associated with the first process of the plurality of processes when the processor is executing the first process of the plurality of processes and to store data associated with the second process of the plurality of processes when the processor is executing the second process of the plurality of processes;
a context save function to save, to the memory, a first number of processor registers of the plurality of processor registers, wherein the first number is at least two and is a proper subset of a total number of processor registers available in the device;
a process data structure corresponding to the first process of the plurality of processes, the process data structure comprising a context save tag corresponding to the context save function; and
an operating system configured to:
identify the context save function using the context save tag from the process data structure;
cause the processor to execute the identified context save function when context switching away from the first process; and
leave one or more processor registers of the plurality of processor registers unsaved when the context switching away from the first process is complete.

15. The device of claim 14, comprising:
a context restore function to restore, from the memory, the first number of processor registers of the plurality of processor registers, wherein:
the process data structure comprises a context restore tag corresponding to the context restore function; and
the operating system configured to:
identify the context restore function using the context restore tag from the process data structure;
cause the processor to execute the identified context restore function when context switching away from the second process to the first process; and
leave one or more processor registers of the plurality of processor registers unrestored when the context switching away from the second process to the first process is complete.

16. The device of claim 14, wherein the context save function comprises instructions to save processor registers that are contiguously addressed.

17. The device of claim 14, wherein:
the process data structure comprises a count field to store a value corresponding to the first number of processor registers of the plurality of processor registers, and
the context save function comprises instructions to determine the number of processor registers to save based on the value of the count field.

18. The device of claim 17, wherein the process data structure comprises an address field to store a value corresponding to a starting address of a starting register of the plurality of processor registers; and
the context save function comprises instructions to save at least the processor register corresponding to the value stored in the address field.

19. The device of claim 14, wherein the proper subset of the total number of processor registers available in the device corresponds to a maximum number of processor registers used by the first process.

20. The device of claim 14, wherein the total number of processor registers available in the device includes central processing unit registers and co-processor registers.
